(19) United States
(12) Patent Application Publication
(10) Pub. No.: US 2015/0260755 A1
(43) Pub. Date: Sep. 17, 2015

(54) GYRO SENSOR DRIVING APPARATUS AND METHOD FOR CONTROLLING THEREOF

(71) Applicant: SAMSUNG ELECTRO-MECHANICS CO., LTD., Suwon-Si (KR)

(72) Inventors: Chang Hyun KIM, Suwon-Si (KR); Yu Heon Yi, Suwon-Si (KR); Sung Tae Kim, Suwon-Si (KR)

(73) Assignee: SAMSUNG ELECTRO-MECHANICS CO., LTD., Suwon-Si (KR)

(21) Appl. No.: 14/629,486

(22) Filed: Feb. 23, 2015

(30) Foreign Application Priority Data
Mar. 11, 2014 (KR) 10-2014-0028506

(51) Int. Cl. G01P 21/00; G01P 15/14

(52) U.S. Cl. CPC G01P 21/00; G01P 15/14

(57) ABSTRACT

Disclosed herein is a gyro sensor driving apparatus including a driving displacement signal processing unit processing a driving displacement signal input from a gym sensor and a driving signal formed by using the driving displacement signal to the gym sensor, a sensing signal processing unit converting a sensing signal input from the gyro sensor into a voltage signal and subsequently detecting a direct current (DC)-type gyro signal value through a demodulation process (mixing) using the driving displacement signal; and a quadrature signal correcting unit detecting a DC-type quadrature signal value and subsequently applying a DC-type correction signal corresponding to an integrated value of the quadrature signal value to the gyro sensor.

### CROSS REFERENCE TO RELATED APPLICATION

This application claims the benefit of Korean Patent Application No. 10-2014-0028506, filed on Mar. 11, 2014, entitled “Gyro Sensor Driving Apparatus and Method for Controlling Thereof”, which is hereby incorporated by reference in its entirety into this application.

### BACKGROUND OF THE INVENTION

1. Technical Field

The present invention relates to a gyro sensor driving apparatus and a method for controlling thereof.

2. Description of the Related Art

Recently, mobile devices equipped with a gyro sensor (an accelerometer, an angular velocity (gyro) sensor, or a geomagnetic sensor, and the like) using inertial input applied from the outside have been released. Among the various gyro sensors, a gym sensor measures an angular velocity by detecting an amount of applied rotatory power of an object. An angular velocity may be obtained by Coriolis' force “F=2mΩV” wherein m is mass of a sensor Mass, Ω is an angular velocity desired to be measured, and V is a motion velocity of the sensor Mass.

Gyro sensors are commonly used for attitude control in aircraft, rockets, robots, and the like, and for image stabilization (or hand-shaking correction) in cameras, binoculars, and the like. Recently, gyro sensors have been installed in smart phones, and in order to smoothly perform the foregoing function, gyro sensors are required to have a high signal-to-noise ratio (SNR).

Thus, in order to increase an SNR of a gyro sensor, an output signal from a gyro sensor should be large and noise related to a control circuit of the gyro sensor controlling the output signal should be small. Conventionally, as described in the related art document below, a gyro sensor cannot secure a high SNR due to noise generated as a quadrature signal (i.e., a signal due to mismatch of components generated during the process of manufacturing a gyro sensor) and jitter (phase noise) of a synchronous detection clock in connection with the control circuit are mixed.

Also, ideally, a considerable portion of the quadrature signal may be removed through a synchronous detection circuit (or a demodulator), but noise is generated by the quadrature signal due to a change in PVT of the control circuit or a degradation of the gyro sensor due to an asymmetrical form of a gyro sensor, or the like.

### RELATED ART DOCUMENT

(Patent document 1) 2009-508129 JP

### SUMMARY OF THE INVENTION

The present invention has been made in an effort to provide a gyro sensor driving apparatus capable of detecting a quadrature signal value in real time by a quadrature signal correcting unit and applying a correction signal to correct the quadrature signal value to thus minimize the quadrature signal that may be generated due to an asymmetrical shape of a gyro sensor, and a method for controlling thereof.

According to an embodiment of the present invention, there is provided a gyro sensor driving apparatus, including: a driving displacement signal processing unit converting a driving displacement signal input from a gyro sensor into a voltage signal, phase-shifting the converted driving displacement signal, and applying a driving signal formed by using the phase-shifted signal to the gyro sensor; a sensing signal processing unit converting a sensing signal input from the gyro sensor into a voltage signal and subsequently detecting a direct current (DC)-type gyro signal value through a demodulation process (mixing) using the driving displacement signal; and a quadrature signal correcting unit detecting a DC-type quadrature signal value through a demodulation process (mixing) using the driving displacement signal which has been converted into the voltage signal and the sensing signal, and subsequently applying a DC-type correction signal corresponding to an integrated value of the quadrature signal value to the gyro sensor.

The driving displacement processing unit may include: a first charge amplifier converting the driving displacement signal output from the gyro sensor into a voltage signal, amplifying the voltage signal, and subsequently outputting the amplified signal; a phase shift module shifting a phase of the driving displacement signal by 90°; a driving unit generating a driving signal allowing the driving displacement signal to have a predetermined amplitude by using an output signal from the phase shift module, and applying the driving signal to the gyro sensor; and an alternate current (AC) coupling module provided between the gyro sensor and the first charge amplifier and blocking the correction signal from being input to the driving displacement signal processing unit.

The sensing signal processing unit may include: a second charge amplifier converting the sensing signal output from the gyro sensor into a voltage signal, amplifying the voltage signal, and subsequently outputting the amplified signal; a second demodulating module performing a demodulation process of mixing the sensing signal and the driving displacement signal; and a second filter module filtering high frequency noise from an output signal from the second demodulating module and outputting a predetermined DC-type gyro signal value.

The quadrature signal correcting unit may include: a quadrature signal detecting module detecting a DC-type quadrature signal value through a demodulation process of mixing the driving displacement signal and the sensing signal; and a quadrature signal correcting module generating a DC-type correction signal for removing the DC-type quadrature signal value, and applying the generated DC-type correction signal to the gyro sensor.

The quadrature signal detecting module may include: a first demodulating module performing a demodulation process of mixing the sensing signal and the driving displacement signal; and a first filter module filtering high frequency noise from an output signal from the first demodulating module and outputting a predetermined DC-type quadrature signal value.

The first filter module may be a low pass filter.

The second filter module may be a low pass filter.

The quadrature signal correcting module may include an integrator performing integration on the quadrature signal value, generating a DC-type correction signal corresponding to an integrated value of the quadrature signal value, and applying the generated DC-type correction signal to the gyro sensor.

According to another embodiment of the present invention, there is provided a method for controlling a gyro sensor driving apparatus, including a driving displacement signal processing operation of converting, by a driving displacement signal processing unit, a driving displacement signal input from a gyro sensor, shifting a phase of the voltage signal, and applying a driving signal formed by using the phase-shifted signal to the gyro sensor; a sensing signal processing operation of converting, by a sensing signal processing unit, a sensing signal input from the gym sensor into a voltage signal, and detecting a direct current (DC)-type gyro signal value through a demodulation process (mixing) using the driving displacement signal; and a quadrature signal correcting operation of detecting, by a quadrature signal correcting unit, a DC-type quadrature signal value through a demodulation process (mixing) using the driving displacement signal which has been converted into the voltage signal and a sensing signal, and applying a DC-type correction signal corresponding to an integrated value of the quadrature signal value to the gyro sensor.

The driving displacement signal processing operation may include: converting, by a first charge amplifier, the driving displacement signal output from the gyro sensor into a voltage signal, amplifying the voltage signal, and outputting the amplified signal; shifting, by a phase shift module, a phase of the driving displacement signal by 90°; generating, by a driving unit, a driving signal allowing the driving displacement signal to have a predetermined amplitude by using an output signal from the phase shift module, and applying the driving signal to the gym sensor; and blocking, by an alternating current (AC) coupling module provided between the gyro sensor and the first charge amplifier, the correction signal from being input to the driving displacement signal processing unit.

The sensing signal processing operation may include: converting, by the second charge amplifier, the sensing signal output from the gyro sensor into a voltage signal, amplifying the voltage signal, and subsequently outputting the amplified signal; performing, by a second demodulating module, a demodulation process of mixing the sensing signal and the driving displacement signal; and filtering, by a second filter module, high frequency noise from an output signal from the second demodulating module, and outputting a predetermined DC-type gyro signal value.

The quadrature signal correcting operation may include: detecting, by a quadrature signal detecting module, a DC-type quadrature signal value through a demodulation process of mixing the driving displacement signal and the sensing signal; and generating, by a quadrature signal correcting module, a DC-type correction signal for removing the DC-type quadrature signal value, and applying the correction signal to the gyro sensor.

The quadrature signal value detecting operation may include: performing, by a first demodulating module, a demodulation process of mixing the sensing signal and the driving displacement signal; and filtering, by a first filter module, high frequency noise from an output signal from the first demodulating module, and outputting a predetermined DC-type quadrature signal value.

The applying of the correction signal to the gyro sensor may include: performing integration, by an integrator, on the quadrature signal value; and generating a DC-type correction signal corresponding to an integrated value of the quadrature signal value and applying the generated DC-type correction signal to the gyro sensor.

The second filter module may be a low pass filter.

The first filter module may be a low pass filter.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram illustrating a gyro sensor driving apparatus according to an embodiment of the present invention;

FIG. 2 is a flow chart illustrating a method for controlling a gyro sensor driving apparatus according to an embodiment of the present invention;

FIGS. 3 and 4 are views illustrating a process of processing a quadrature compensation signal and a gyro signal by a sensing signal processing unit according to an embodiment of the present invention;

FIGS. 5 and 6 are views illustrating a process of detecting a quadrature signal by a quadrature signal detecting module according to an embodiment of the present invention; and

FIGS. 7A and 7B are views illustrating a process of correcting a quadrature signal by a correcting module according to an embodiment of the present invention.

### DESCRIPTION OF THE PREFERRED EMBODIMENTS

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side”, and the like, are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

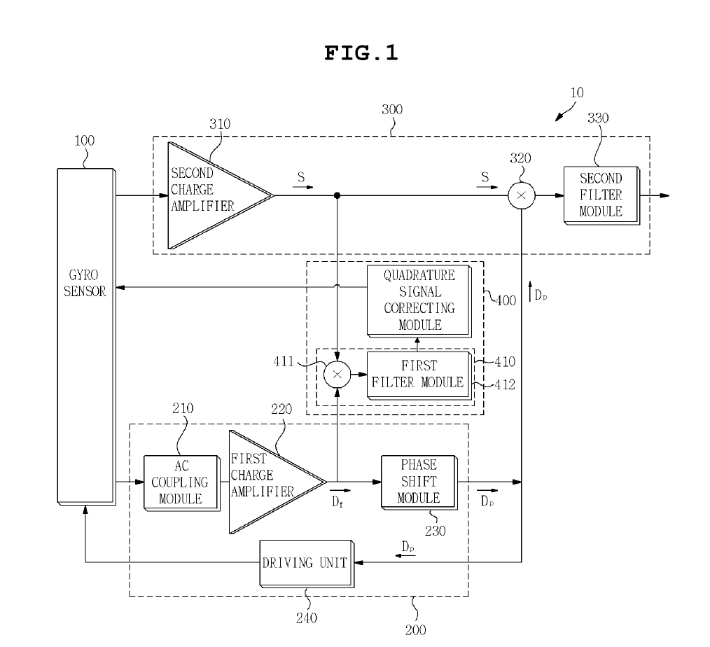

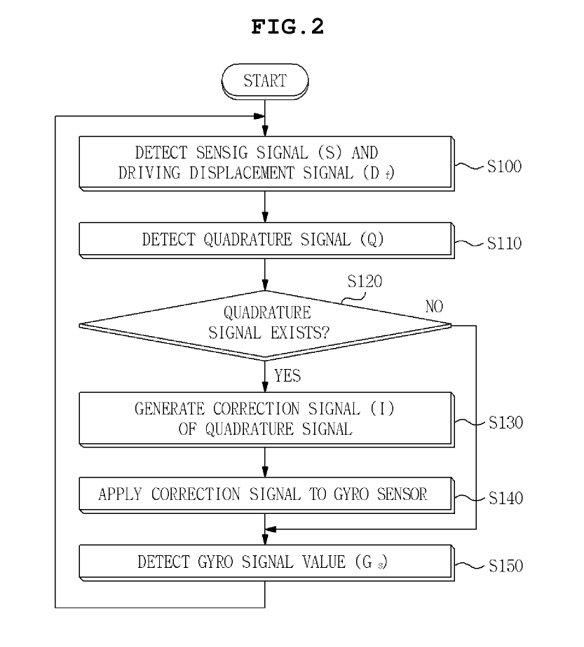

FIG. 1 is a block diagram illustrating a gym sensor driving apparatus according to an embodiment of the present invention, and FIG. 2 is a flow chart illustrating a method for controlling a gyro sensor driving apparatus according to an embodiment of the present invention;

As illustrated in FIG. 1, the gyro sensor driving apparatus according to an embodiment of the present invention includes a gyro sensor 100, a driving displacement signal processing unit 200, a sensing signal processing unit 300, and a quadrature signal correcting unit 180.

The gyro sensor 100 is a sensor that includes a driving mass (not shown) and detects an angular velocity in three axial directions positioned in a space. The driving mass (not shown) is vibrated by a driving signal applied to the gyro sensor 100, a driving displacement signal D_{f} refers to a feedback signal (sine wave) output by the vibration. The driving displacement signal D_{f} includes first and second driving displacement signals D_{f1} and D_{f2} having a 180° phase difference therebetween.

The driving displacement signal processing unit 200 may convert the driving displacement signal input from the gyro sensor 100 into a voltage signal shift a phase of the converted voltage signal, and apply a driving signal (not shown) formed by using the phase-shifted signal to the gyro sensor 100. The driving displacement signal processing unit 200 may include a first charge amplifier 220, a phase shift module 230, a driving unit 240, and an alternate current (AC) coupling module 210.

The first charge amplifier 220 may convert the driving displacement signal D_{f} output from the gym sensor 100 into a voltage signal and amplify the converted voltage signal to output driving displacement signals D_{f1} and D_{f2} (S100). The phase shift module 230 may shift a phase of the first driving displacement signal D_{f1} or the second driving displacement signal D_{f2} by 90° to output a signal Dₚ.

The driving unit 240 may generate a driving signal D allowing the driving mass to resonate with a predetermined amplitude, by using the output signal Dₚ from the phase shift module 230, and apply the driving signal D to the gym sensor 100.

The AC coupling module 210 is provided between the gyro sensor 100 and the first charge amplifier 220, blocks a connection signal I from being input to the driving displacement signal processing unit 200. Details thereof will be described hereinafter.

The sensing signal processing unit 300 may convert a sensing signal input from the gyro sensor 100 into a voltage signal (S100) and detect direct current (DC)-type gyro signal values P₁ and P₂ through a demodulation process (mixing) using the driving displacement signal D_{f} (S150). The sensing signal processing unit 300 may include a second charge amplifier 310, a second demodulation module 320, and a second filter module 330. Details thereof will be described hereinafter.

The quadrature signal correcting unit 180 may detect a DC quadrature signal value through a demodulation process (mixing) using the driving displacement signal as a voltage signal and the sensing signal (5110) to determine whether a quadrature signal exists (S120). When the quadrature signal exists, the quadrature signal correcting unit 180 may generate a DC-type correction signal I corresponding to an integrated value of the quadrature signal value (S130) and apply the generated DC-type correction signal to the gyro sensor 100 (S140). The quadrature signal correcting unit 180 may include a quadrature signal detecting module 181 and a quadrature signal correcting module 182. Details thereof will be described hereinafter.

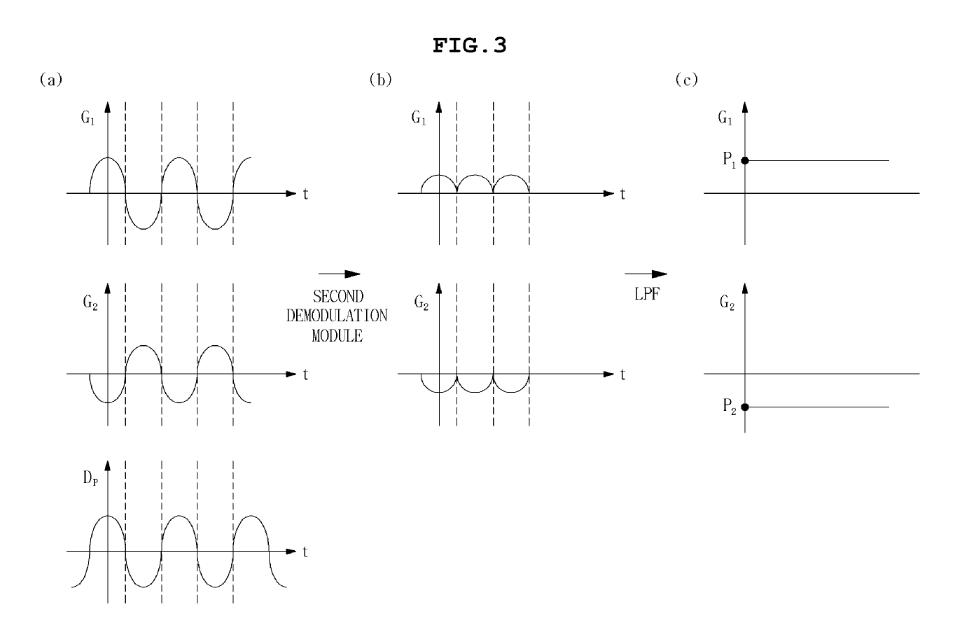

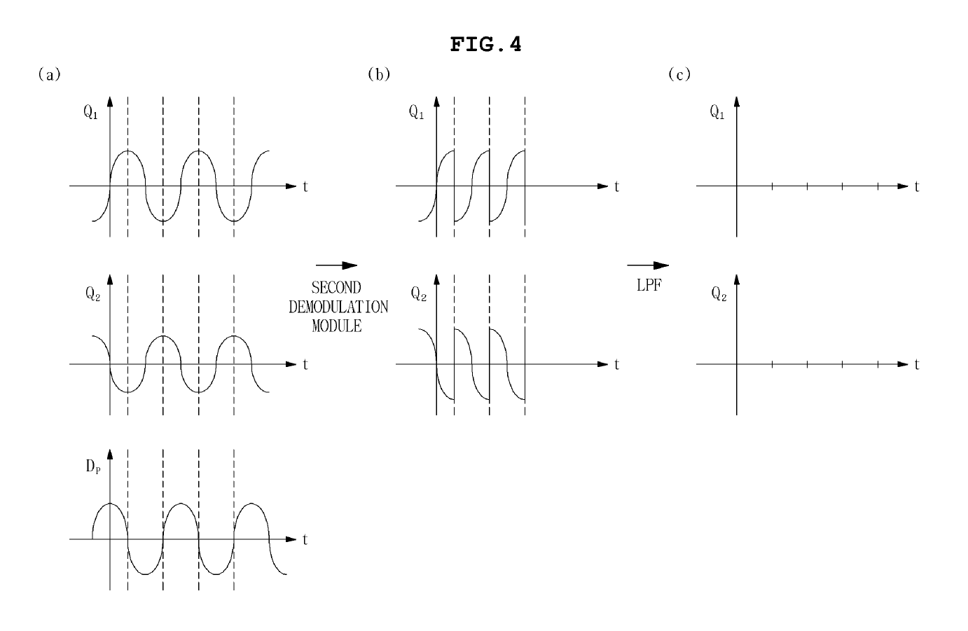

Hereinafter, a process of processing the sensing signal and the quadrature signal by the sensing signal processing unit of the gyro sensor driving apparatus according to an embodiment of the present invention will be described with reference to FIGS. 3 and 4.

FIG. 3 is a view illustrating a process of processing a gyro signal by the sensing signal processing unit according to an embodiment of the present invention, and FIG. 4 is a view illustrating a process of processing a quadrature compensation signal by the sensing signal processing unit according to an embodiment of the present invention.

The sensing signal processing unit 300 may convert the sensing signal input from the gyro sensor 100 into a voltage signal, and detect DC-type gym signal values P₁ and P₂ through a demodulation process (mixing) using the driving displacement signal D_{f}. The sensing signal processing unit 300 may include the second charge amplifier 310, the second demodulating module 320, and the second filter module 330.

The second charge amplifier 310 may convert a change in an amount of electric changes generated in a sensing electrode (not shown) from the gyro sensor 100 into a voltage signal and amplify the voltage signal to output a sensing signal S. The sensing signal S may include first and second sensing signals S1 and S2 having a 180° phase difference therebetween.

The second demodulating module 320 may perform a demodulation process of multiplying (mixing) the first and second sensing signals S1 and S2 and the first driving displacement signal D_{f1} or the second driving displacement signal D_{f2}, and the second filter module 330 may filter high frequency noise from an output signal from the second demodulating module 320 and output a predetermined DC-type gyro signal value. Here, the second filter module 330 may be a low pass filter.

Namely, as illustrated in FIG. 3, the second demodulating module 320 may perform a demodulation process of mixing the output signal DP from the phase shift module 230 with the first and second gyro signals G₁ and G₂ (FIG. 3A) included in the first and second sensing signals S1 and S2 input from the second charge amplifier 310 (FIG. 3B), and the second filter module 330 may filter high frequency noise of a signal output from the second demodulating module 320 to output predetermined first and second DC-type gyro signal values P₁ and P₂ (FIG. 3C).

Also, as illustrated in FIG. 4, in principle, the second demodulating module 320 may perform a demodulation process of mixing the output signal Dₚ from the phase shift module 230 to first and second quadrature signals Q₁ and Q₂ (FIG. 4A) included in the first and second sensing signals S1 and S2 input from the second charge amplifier 310 (FIG. 4B), and the second filter module 330 may filter high frequency noise of the first and second quadrature signals Q₁ and Q₂ output from the second demodulating module 320 to remove the first and second quadrature signals Q₁ and Q₂. However, in a case in which jitter is included in the output signal Dₚ, noise may be generated due to combination with the first and second quadrature signals Q₁ and Q₂ (FIG. 4A), the quadrature signals Q₁ and Q₂ may be detected by the quadrature signal correcting unit in real time and removed to reduce noise of an overall driving circuit.

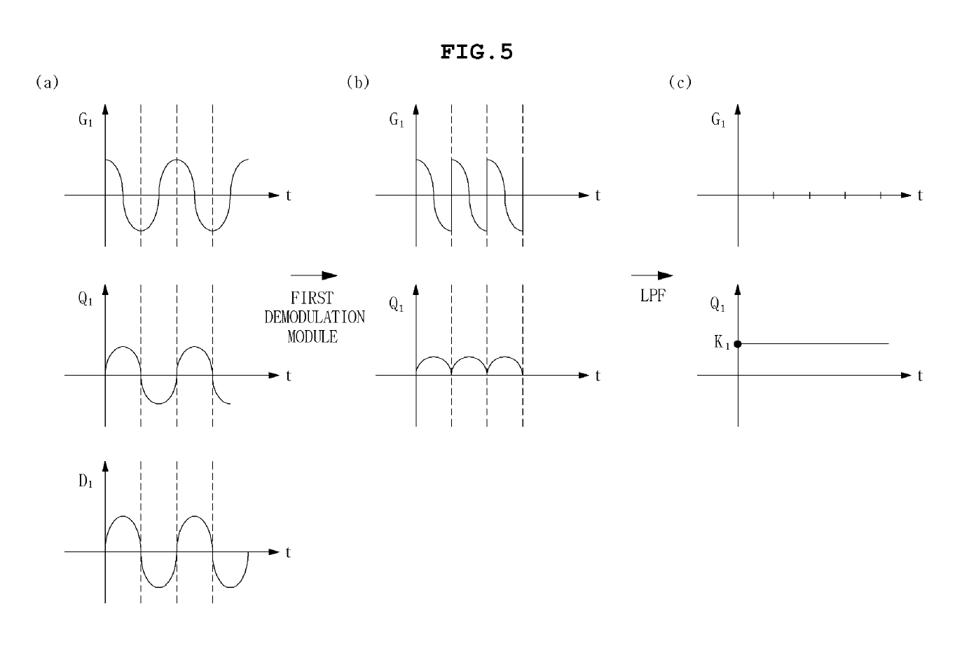

Hereinafter, a method for detecting a quadrature signal and correcting the same by the quadrature signal correcting unit according to an embodiment of the present invention will be described in detail with reference to FIGS. 5 through 7.

The quadrature signal correcting unit 180 may detect a DC-type quadrature driving signal value through the demodulation processing (mixing) using the sensing signals converted into the voltage signals, and apply the DC-type correction signal I corresponding to an integrated value of the quadrature signal value to the gyro sensor 100. The quadrature signal correcting unit 180 may include a quadrature driving signal detecting module 181 and a quadrature signal correcting module 182.

The quadrature driving signal detecting module 181 may detect the DC-type quadrature signal value through a demodulation process of mixing the driving displacement signal D_{f} and the sensing signals S1 and S2. The quadrature driving signal detecting module 181 may include a first demodulating module 411 and a first filter module 412.

The first demodulating module 411 may perform a demodulation process of mixing the first and second sensing signals S1 and S2 and the first driving displacement signal D_{f1} and the second driving displacement signal D_{f2}, and the first filter module 412 may filter high frequency noise from an output signal from the first demodulating module 411 to output a predetermined DC-type quadrature signal value. Here, the first module 412 may be a low-pass filter.

Namely, as illustrated in FIG. 5, the first demodulating module 411 may perform a demodulation process of mixing the first driving displacement signal D_{f1} among the driving displacement signals D_{f} output from the second charge amplifier 310 to the first gyro signal G1 and to the first quadrature signal Q₁ included in the first sensing signals input from the second charge amplifier (FIG. 5B), and the first filter module 412 filter high frequency noise output from the first demodulating module 411 and output a predetermined DC-type first quadrature signal value K₁, and during the filtering process, the first gyro signal value may be removed through an averaging process (FIG. 5C).

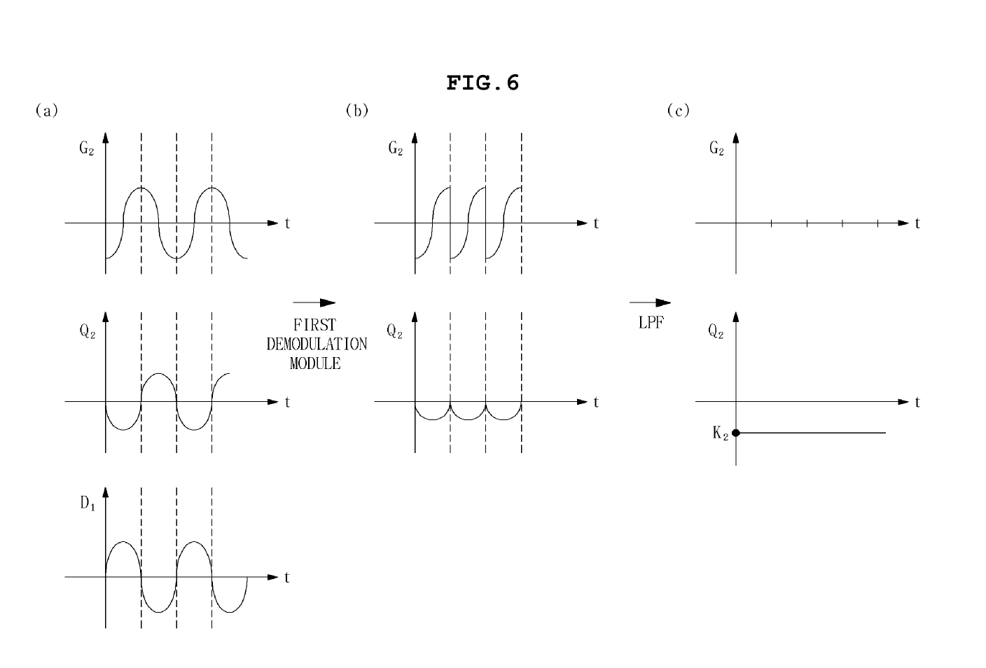

Also, as illustrated in FIG. 6, the first demodulating module 411 may perform a demodulation process of mixing the first driving displacement signal D_{f1} among the driving displacement signals D_{f} output from the second charge amplifier 310 to the second gyro signal G₂ and the second quadrature signal Q2 included in the second sensing signals S2 input from the second charge amplifier 310 (FIG. 6B), and the first filter module 412 filter high frequency noise of a signal output from the first demodulating module 411 to output a predetermined DC-type second quadrature signal value K₂, and during the filtering process, the second gyro signal value may be removed through an averaging process (FIG. 6C).

The quadrature signal correcting module 182 generates a DC-type correction signal I to remove the DC-type quadrature signal values K₁ and K₂ and apply the generated correction signal I to the gyro sensor.

Namely, the quadrature signal correcting module 182 may include an integrator performing integration on the quadrature signal values K₁ and K₂ and may generate a DC-type correction signal corresponding to an integrated value of the quadrature signal value and apply the generated correction signal to the gyro sensor.

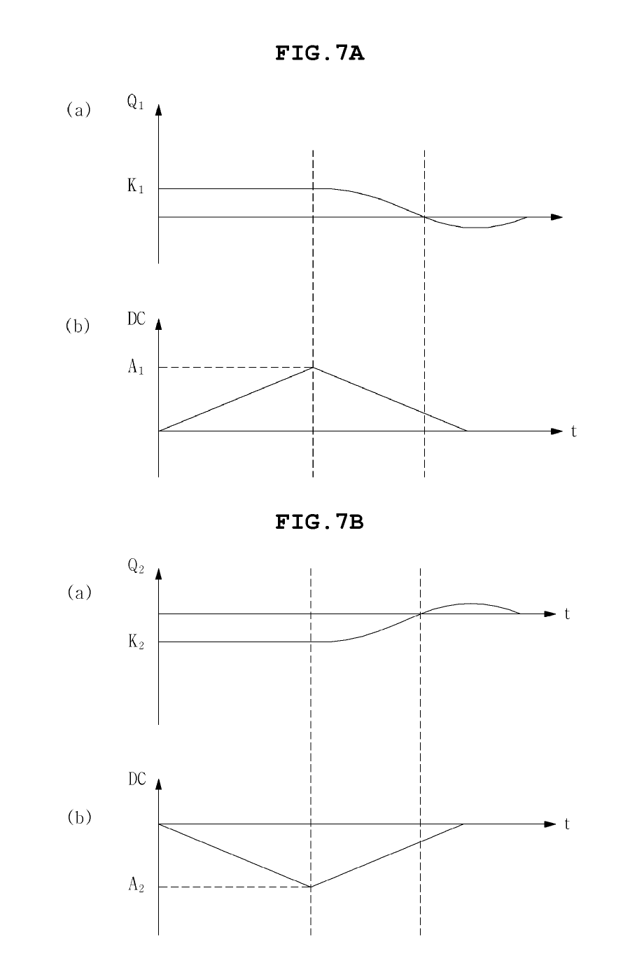

As illustrated in FIG. 7, 1) when the quadrature signal detecting module 181 detects the first quadrature signal value K₁ through a demodulation process of the first quadrature signal Q₁, the quadrature signal detecting module 181 may perform integration on the first quadrature signal value K₁ and directly apply a DC voltage (correction signal I₁) corresponding to the integrated value A₁ to the first driving displacement signal output electrode (not shown) of the gyro sensor 100 to correct the first quadrature signal value K₁ (FIGS. 7A), and 2) when the quadrature signal detecting module 181 detects the second quadrature signal value K₂ through a demodulation process of the second quadrature signal Q₂, the quadrature signal detecting module 181 may perform integration on the second quadrature signal value K₂ and directly apply a DC voltage (correction signal I₂) corresponding to the integrated value A₂ to the second driving displacement signal output electrode (not shown) of the gyro sensor to correct the second quadrature signal value K₂ (FIG. 7B)

Here, the AC coupling module 210 provided between the gym sensor 100 and the second charge amplifier 310 may prevent the DC-type correction signal I from being input to the second charge amplifier 310 and allow only driving displacement signal D_{f} in a pulse wave form to be input thereto.

As discussed above, in the driving apparatus for processing an output signal from the gyro sensor, the sensing signals and the driving displacement signals are demodulated by the quadrature signal correcting unit to detect a DC-type quadrature signal value in real time, a correction signal for correcting the quadrature signal value is calculated and directly applied to the gyro sensor, whereby a generation of a quadrature signal due to an asymmetrical shape of the gyro sensor, or the like, may be minimized, and thus, reliability of an output signal from the gyro sensor may be secured.

Also, since a quadrature signal is detected by the quadrature signal correcting unit and a correction signal for correcting the quadrature signal is directly applied to the gyro sensor and corrected in real time, an amplification gain of the second charge amplifier provided in front of the driving apparatus is increased, thus minimizing a generation of noise of the overall driving apparatus.

According to the preferred embodiments of the present invention, in the control circuit for processing an output signal from the gyro sensor, the sensing signals and the driving displacement signals are demodulated by the quadrature signal correcting unit to detect a DC-type quadrature signal value in real time, a correction signal for correcting the quadrature signal value is calculated and directly applied to the gyro sensor, whereby a generation of a quadrature signal due to an asymmetrical shape of the gyro sensor, or the like, may be minimized, and thus, reliability of an output signal from the gyro sensor may be secured.

Also, since a quadrature signal is detected by the quadrature signal correcting unit and a correction signal for correcting the quadrature signal is directly applied to the gyro sensor and corrected in real time, an amplification gain of the second charge amplifier provided in front of the driving apparatus is increased, thus minimizing a generation of noise of the overall driving apparatus.

Although the embodiments of the present invention have been disclosed for illustrative purposes, it will be appreciated that the present invention is not limited thereto, and those skilled in the art will appreciate that various modifications, additions, and substitutions are possible, without departing from the scope and spirit of the invention.

Accordingly, any and all modifications, variations, or equivalent arrangements should be considered to be within the scope of the invention, and the detailed scope of the invention will be disclosed by the accompanying claims.

What is claimed is:

1. A gyro sensor driving apparatus, comprising:
a driving displacement signal processing unit converting a driving displacement signal input from a gyro sensor into a voltage signal, phase-shifting the converted driving displacement signal, and applying a driving signal formed by using the phase-shifted signal to the gyro sensor;
a sensing signal processing unit converting a sensing signal input from the gyro sensor into a voltage signal and subsequently detecting a direct current (DC)-type gym signal value through a demodulation process (mixing) using the driving displacement signal; and
a quadrature signal correcting unit detecting a DC-type quadrature signal value through a demodulation process using the driving displacement signal which has been converted into the voltage signal and the sensing signal, and subsequently applying a DC-type correction signal corresponding to an integrated value of the quadrature signal value to the gyro sensor.

2. The gyro sensor driving apparatus as set forth in claim 1, wherein the driving displacement processing unit includes:
a first charge amplifier converting the driving displacement signal output from the gyro sensor into a voltage signal, amplifying the voltage signal, and subsequently outputting the amplified signal;
a phase shift module shifting a phase of the driving displacement signal by 90°;
a driving unit generating a driving signal allowing the driving displacement signal to have a predetermined amplitude by using an output signal from the phase shift module, and applying the driving signal to the gym sensor; and
an alternate current (AC) coupling module provided between the gyro sensor and the first charge amplifier and blocking the correction signal from being input to the driving displacement signal processing unit.

3. The gyro sensor driving apparatus as set forth in claim 2, wherein the sensing signal processing unit includes:
a second charge amplifier converting the sensing signal output from the gyro sensor into a voltage signal, amplifying the voltage signal, and subsequently outputting the amplified signal;
a second demodulating module performing a demodulation process of mixing the sensing signal and the driving displacement signal; and
a second filter module filtering high frequency noise from an output signal from the second demodulating module and outputting a predetermined DC-type gyro signal value.

4. The gyro sensor driving apparatus as set forth in claim 3, wherein the quadrature signal correcting unit includes:
a quadrature signal detecting module detecting a DC-type quadrature signal value through a demodulation process of mixing the driving displacement signal and the sensing signal; and
a quadrature signal correcting module generating a DC-type correction signal for removing the DC-type quadrature signal value, and applying the generated DC-type correction signal to the gyro sensor.

5. The gyro sensor driving apparatus as set forth in claim 4, wherein the quadrature signal detecting module includes:
a first demodulating module performing a demodulation process of mixing the sensing signal and the driving displacement signal; and
a first filter module filtering high frequency noise from an output signal from the first demodulating module and outputting a predetermined DC-type quadrature signal value.

6. The gyro sensor driving apparatus as set forth in claim 5, wherein the first filter module is a low pass filter.

7. The gym sensor driving apparatus as set forth in claim 3, wherein the second filter module is a low pass filter.

8. The gyro sensor driving apparatus as set forth in claim 5, wherein the quadrature signal correcting module includes an integrator performing integration on the quadrature signal value, generating a DC-type correction signal corresponding to an integrated value of the quadrature signal value, and applying the generated DC-type correction signal to the gyro sensor.

9. A method for controlling a gyro sensor driving apparatus, the method comprising:
a driving displacement signal processing operation of converting, by a driving displacement signal processing unit, a driving displacement signal input from a gym sensor into a voltage signal, shifting a phase of the voltage signal, and applying a driving signal formed by using the phase-shifted signal to the gyro sensor;
a sensing signal processing operation of converting, by a sensing signal processing unit, a sensing signal input from the gyro sensor into a voltage signal, and detecting a direct current (DC)-type gyro signal value through a demodulation process (mixing) using the driving displacement signal; and
a quadrature signal correcting operation of detecting, by a quadrature signal correcting unit, a DC-type quadrature signal value through a demodulation process (mixing) using the driving displacement signal which has been converted into the voltage signal and a sensing signal, and applying a DC-type correction signal corresponding to an integrated value of the quadrature signal value to the gyro sensor.

10. The method as set forth in claim 9, wherein the driving displacement signal processing operation includes:
converting, by a first charge amplifier, the driving displacement signal output from the gym sensor into a voltage signal, amplifying the voltage signal, and outputting the amplified signal;
shifting, by a phase shift module, a phase of the driving displacement signal by 90°;
generating, by a driving unit, a driving signal allowing the driving displacement signal to have a predetermined amplitude by using an output signal from the phase shift module, and applying the driving signal to the gyro sensor; and
blocking, by an alternating current (AC) coupling module provided between the gyro sensor and the first charge amplifier, the correction signal from being input to the driving displacement signal processing unit.

11. The method as set forth in claim 10, wherein the sensing signal processing operation includes:
converting, by the second charge amplifier, the sensing signal output from the gym sensor into a voltage signal, amplifying the voltage signal, and subsequently outputting the amplified signal;
performing, by a second demodulating module, a demodulation process of mixing the sensing signal and the driving displacement signal; and
filtering, by a second filter module, high frequency noise from an output signal from the second demodulating module, and outputting a predetermined DC-type gyro signal value.

12. The method as set forth in claim 11, wherein the quadrature signal correcting operation includes:
detecting, by a quadrature signal detecting module, a DC-type quadrature signal value through a demodulation process of mixing the driving displacement signal and the sensing signal; and
generating, by a quadrature signal correcting module, a DC-type correction signal for removing the DC-type quadrature signal value, and applying the correction signal to the gyro sensor.

13. The method as set forth in claim 12, wherein the quadrature signal value detecting operation includes:
performing, by a first demodulating module, a demodulation process of mixing the sensing signal and the driving displacement signal; and
filtering, by a first filter module, high frequency noise from an output signal from the first demodulating module, and outputting a predetermined DC-type quadrature signal value.

14. The method as set forth in claim 13, wherein the applying of the correction signal to the gyro sensor includes:
performing integration, by an integrator, on the quadrature signal value; and
generating a DC-type correction signal corresponding to an integrated value of the quadrature signal value and applying the generated DC-type correction signal to the gyro sensor.

15. The method as set forth in claim 11, wherein the second filter module is a low pass filter.

16. The method as set forth in claim 13, wherein the first filter module is a low pass filter.
